(19) United States
(12) Patent Application Publication
(10) Pub. No.: US 2005/0124224 A1
(43) Pub. Date: Jun. 9, 2005

(54) Adapter for connecting an optoelectronic transducer module to a printed circuit board, transmitting and/or receiving arrangement with such an adapter, optoelectronic transducer module and method for its production

(76) Inventor: Nikolaus Schunk, Maxhutte-Haidhof (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/980,702

(22) Filed: Nov. 3, 2004

(30) Foreign Application Priority Data
Nov. 3, 2003 (DE) DE 103 51 704.9

(51) Int. Cl. H01R 33/92

(52) U.S. Cl. 439/638

(57) ABSTRACT

The invention relates to an adapter and to an optoelectronic transmitting and/or receiving arrangement with an optoelectronic transducer module and a corresponding adapter. The adapter has an adapter body with at least one planar side, a plurality of first electrical contacts, and a plurality of second electrical contacts. The first electrical contacts are arranged on a planar side of the adapter body and the second electrical contacts are arranged on another side of the adapter body, wherein respective ones of the first electrical contacts and second electrical contacts are connected to one another by means of a conductor running inside the adapter body.

### REFERENCE TO RELATED APPLICATIONS

This application claims the benefit of the priority date of German application DE 103 51 704.9, filed on Nov. 3, 2003, the contents of which are herein incorporated by reference in their entirety.

### FIELD OF THE INVENTION

The invention relates to an adapter for connecting an optoelectronic transducer module to a printed circuit board and to a transmitting and/or receiving arrangement with such an adapter. The invention also relates to an optoelectronic transducer module as well as a method for producing such an optoelectronic transducer module, the optoelectronic transducer module connectable to the adapter and suitable for use in the transmitting and/or receiving arrangement.

### BACKGROUND OF THE INVENTION

There are known, small devices that are referred to as Small-Form-Factor (SFF) transceivers and Small-Form-Factor-Pluggable (SFP) transceivers, which are arranged in a package. These transceivers may be of a pluggable design (SFP transceivers) or permanently connected to a package (SFF transceivers). Apart from an optoelectronic transducer device, the known transceivers have an internal printed circuit board, which runs parallel to the optical axis of the transceiver and contains electronic circuits for the transducer device such as a driver device and/or a preamplifier device. The transceiver is arranged on a main circuit board, which is electrically connected to the internal printed circuit board, for example, by means of a plug. An SFP transceiver is described for example in DE 101 14 143 A1.

It is disadvantageous that the known transceivers have to be made relatively long because of the presence of the internal printed circuit board. However, integration of the electronic circuits directly in the optoelectronic transducer devices, as an alternative to use of an internal printed circuit board, is only possible in the case of known transducer devices if at the same time the small form factor criterion, which specifies a maximum width of 13.5 mm, is abandoned.

WO 03/076998 A1 describes an optoelectronic transducer module with a transducer component, a carrier on which the transducer component is arranged, a receiving and coupling part, which receives the transducer component and forms a coupling region for coupling on an optical waveguide, and with an electrical activating and/or receiving circuit for the transducer component. It is provided there that the electrical activating and/or receiving circuit is arranged outside the receiving and/or coupling part on a subcarrier, which lies in a plane which runs parallel to the longitudinal axis of the coupling region. Serving as the carrier is a leadframe which is aligned perpendicularly in relation to the longitudinal axis of the coupling region and at its lower end is bent round by 90° and soldered onto the subcarrier by means of an SMD contact.

In the case of the known optoelectronic module, a separate subcarrier is required for the electrical activating and/or receiving circuit, which leads to an increased space requirement. Separate forming of the leadframe is also required (bending round by 90°). Such a formation is not always possible, in particular if recourse is made to optoelectronic modules arranged in standard packages.

There is consequently a need for compact optoelectronic arrangements which can be used in particular in SFP and SFF transceivers and at the same time preferably integrate electrical circuits in the transducer component, so that it is possible to dispense with a separate internal printed circuit board in the transceivers.

There are also known optoelectronic modules, for example from DE 101 50 986 A1, in which a transducer device is arranged on a leadframe and emits and receives light through the leadframe, that is in the direction of the base of the device. The module package is in this case filled with a nontransparent plastic, the opening in the carrier providing an optical window. A disadvantage of optoelectronic modules of this type is that the leadframe has to be provided with an opening. It is also required to arrange the transducer device with the upper side downward on the leadframe or a transparent submount, which is then fastened on the leadframe.

U.S. Pat. No. 5,897,338 describes a method for producing an optoelectronic transducer module in which an optoelectronic transmitting or receiving chip arranged on a leadframe is encapsulated. The leadframe with the transmitting or receiving chip is in this case arranged in an injection mold and, with the exception of an optical window, cast with a nontransparent plastics material, which forms a plastic package. Coupling in and out of light takes place from the upper side of the package, that is to say not through the leadframe. To provide an optical window, the injection mold has a clearance, in which a removable insert is inserted before encapsulation. The removable insert reaches up to the transmitting or receiving chip, a heat-resistant deformable material, for instance of silicone gel, being arranged between these parts. After the encapsulation, the insert is removed along with the deformable material. The deformable material protects the optically active region of the transmitting or receiving chip during the encapsulation. A disadvantage in the case of the known method is that a complex injection mold with a clearance is required.

There is a need for simple and effective constructions and production methods for optoelectronic transducer modules in which the light of a transducer device enters or leaves not through the carrier or the leadframe but through the upper side, that is to say the optical window is located on the upper side (top window).

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention is directed to an optoelectronic transmitting and/or receiving arrangement and components associated therewith that take up little space and can preferably be used in small-form-factor optoelectronic transceivers. Furthermore, an optoelectronic transceiver module with an optical window on the upper side and a method for its production are provided, it being intended that the transducer module can be used as a component of the transmitting and/or receiving arrangement.

On this basis, the solution according to the invention comprises an adapter with a plurality of first contacts and a plurality of second contacts on different sides of a nonconducting adapter body, which are respectively connected to one another by a conductor. In this case, the adapter forms a two-dimensional pattern of first contacts on a planar side, facing an optoelectronic module, and a two-dimensional or three-dimensional pattern of second contacts on another side of the module. The second contacts can be connected to a circuit board or printed circuit board directly or by means of a further connecting element. The conductors of the adapter undergo three-dimensional guidance within the adapter body.

The spatial arrangement of the components is preferably such that the optical axis of a transducer module electrically connected to a circuit board by the adapter lies in a plane parallel to the plane of the circuit board.

The provision of the adapter according to the invention makes it possible to arrange a transducer module in a transceiver in a space-saving manner. The adapter is in this case connected to a circuit board directly or by means of a further element, so that the use of an internal printed circuit board is no longer required in the transceiver if the required electrical wiring devices for the transducer devices are integrated in the transducer module. By dispensing with an internal printed circuit board, it is possible to make the transceiver package particularly compact and short.

For the purposes of the present invention, a leadframe is understood as meaning any system carrier made of metal or conductive material which has contact leads or contact pins and a mounting surface for fastening a transducer component or other electronic component.

In a preferred refinement, the conductors form a conductor pattern on a leadframe basis, a conductor respectively being formed by an elongate metal structure, the ends of which respectively provide a first and a second electrical contact. The leadframe pattern is cast with a plastic, which forms the adapter package.

The arrangement of the second contacts may take place in various ways. In a first variant, the second contacts may be arranged on an underside of the adapter body which runs perpendicularly in relation to the side provided with the first contacts. A vertically pluggable adapter is then obtained.

In a second variant, it may be provided that the second contacts are arranged on a rear side of the adapter, which is opposite from the side provided with the first contacts. A horizontally pluggable adapter is then obtained.

In principle, the arrangement of the first contacts of the adapter may be formed in any way desired on the basis of a required or expedient arrangement of the second contacts. In a simple refinement, it is provided in this case that the second contacts are arranged in at least two spaced-apart rows.

In a further preferred refinement, it is provided that the conductors extend from the first contacts on the planar front side of the adapter body in the direction of the rear side of the adapter body in such a way that they form spaced-apart upper and lower contacts in a rearward, protruding coupling region of the adapter body. A horizontally pluggable adapter is in turn produced in this case.

The optoelectronic transmitting and/or receiving device has a transducer module and an adapter, which are connected to one another in such a way that the module package is arranged with its underside (i.e. that side through which no light passes) on the planar side with the first electrical contacts of the adapter body, and the first electrical contacts of the adapter are electrically connected to contact leads of the leadframe of the transducer module.

In a second aspect of the invention, the solution according to the invention provides an optoelectronic module which forms an optical window in its upper side, so that light emitted by a transmitting component or received by a receiving component is coupled out or in through the upper side of the module (“Top Optical Window Package”). It is provided in this case that the upper side of the transducer component, facing the upper side of the module package, is connected by means of an optically transparent adhesive to a transparent optical functional body, which provides an optical window in the upper side of the package, and the optical functional body is laterally surrounded by the casting compound of the module package.

In a preferred refinement, the optical functional body is an optically transparent body with a beam-shaping surface, via which light is coupled out of and into the module. Alternatively, the optical functional body is formed by a mode funnel, the diameter of which increases in the direction of the module surface. The mode funnel has in this case light-guiding properties as a result of a vapor-deposited metallic coating of the side wall or as a result of a core-casing structure.

In an advantageous embodiment, the optical functional body has overlaps, by means of which a form-locking engagement with the casting material of the module package is provided, so that the functional body is securely anchored in the package.

In a further advantageous refinement, the optical functional body has at least one lateral clearance, in which a bonding wire fastened on the surface of the transducer component can be arranged. This avoids the optical functional body from damaging one or more bonding wires that lead to the surface of the transducer component.

It may be provided that the casting material of the package forms structures for the passive coupling of an optical waveguide or a plug of an optical waveguide. In this way, the structures required for the coupling of an optical fiber are provided in a simple way and without additional parts.

In a preferred refinement of the module according to the invention, it is provided that the casting material consists of an optically transparent material, the thermal properties of which are adapted to the thermal properties of other components of the transducer module, in particular the thermal properties of the leadframe and of the transducer component, by adding fillers. This is possible since the optical window is provided by a separate part, that is the optical functional element. The grain size of the fillers is preferably chosen to be large enough that penetration of the filling bodies into the region of the optical window (on account of production tolerances) is not possible.

The invention also provides a method for producing an optoelectronic transducer module. The method is characterized in that a transparent optical functional body is arranged on the injection molding cover of an injection molding device. Furthermore, an optically transparent adhesive is applied to the upper side of a transducer component which is mounted on the leadframe. After introducing the transducer component that is arranged on the leadframe into the injection molding device and closing the latter, the optical functional body comes into contact with the optically transparent adhesive. Thereafter, a casting compound is introduced into the injection molding tool. As a result, an optical window which comprises a different material than the package of the transducer is defined in the transducer module. Consequently, said transducer package can be formed by a casting material which is adapted in its thermal properties to the thermal properties of the module. In addition, a beam-shaping surface can be provided directly by the optical functional body, so that the fitting of a separate lens on the module package is not required.

A further advantage of the method according to the invention is that production tolerances in the chain comprising the leadframe, transducer component (possibly with submount), adhesive and package surface or optical functional surface are absorbed by the transparent adhesive.

In a preferred refinement of the method, the optical functional element is fitted into a lens structure incorporated in the injection molding cover. This takes place in the application of the optical functional element by hot embossing and permits particularly good shaping of the lens. At the same time, it must be ensured by releasing means that the embossed functional body is easily detached from an underlying surface on which it is transported into place and remains adhering to the injection molding cover (until placement on the adhesive takes place later). The underlying surface is also to be formed in such a way that no material flow takes place during the hot embossing in that region in which a bonding wire connected to the surface of the transducer component later runs. Rather, the optical functional body is to have a lateral clearance in this region.

In a further preferred refinement of the method, a separate molded body is placed between the optical functional element and the injection molding cover, which body has on its side that is connected to the functional element a structure corresponding to the functional element and on its side that is connected to the injection molding cover is of a planar form. There is then no need for a lens form or other beam-shaping form to be incorporated in the injection molding cover.

It is also provided with preference that, before filling the injection molding device with a casting material, the optically transparent adhesive is cured by heating. The adhesive then reliably withstands the pressure of the injection molding device. It is therefore ensured that during the injection molding no injection molding material gets between the surface of the transducer component and the optical functional body, and consequently into the optical path of rays.

The production of the optoelectronic transducer module preferably takes place in the form of repeats.

### BRIEF DESCRIPTION OF THE DRAWINGS

The invention is explained in more detail below on the basis of several exemplary embodiments with reference to the figures of the drawing, in which:

FIGS. 1a-1c show in a partly sectioned side view three method steps in the production of an optoelectronic transducer component with an optical window on the upper side in an injection molding device;

FIG. 1d shows a view of a detail of the arrangement in the method step of FIG. 1c, an optical functional element that is connected to the surface of the transducer component by means of an adhesive being represented;

FIG. 2 shows a fully produced optoelectronic transducer component in an injection molding device, in a partly sectioned side view;

FIG. 3 shows a fully produced transducer component according to FIG. 2, an additional molded body, which forms a planar surface with respect to the cover of the injection molding device, being provided;

FIG. 4 shows in a partly sectioned side view a further refinement of a transducer component, the optical functional body being formed by a mode funnel;

FIG. 5 shows a plan view of the front side of a transducer module according to FIG. 2, removed from the injection molding device;

FIGS. 6a-6d show several arrangements of a leadframe adapter in conjunction with various forms of construction of optoelectronic transducer modules;

FIG. 7 shows in a sectional view a transmitting and/or receiving arrangement with an optoelectronic transducer and a leadframe adapter, mounted in a surrounding housing and arranged on a circuit board;

FIGS. 8a, 8b show a leadframe adapter in front view and in side view, respectively;

FIGS. 9a-9c show examples of the spatial arrangement of two contacts of a leadframe adapter in a plane parallel to a printed circuit board;

FIG. 10 shows in front view a leadframe adapter with a transmitting module and a leadframe adapter with a receiving module in an arrangement next to each other;

FIG. 11 shows an alternative refinement of a transmitting and/or receiving arrangement in a surrounding housing, in which the leadframe adapter forms engaging structures and has contacts on the rear side;

FIG. 12 shows the arrangement of FIG. 11 after introduction into a housing compartment and with rear-side contacting of the contacts on the rear side of the leadframe adapter by means of a plug-in adapter;

FIG. 13 shows the arrangement of FIG. 12 with an inserted fiber plug;

FIGS. 14a-14c show an exemplary embodiment of a leadframe adapter in a perspective view from behind, both without and with an optoelectronic module;

FIGS. 15a, 15b show a leadframe adapter with an optoelectronic transducer module which is suitable for coupling with a single-mode fiber, in front view and in side view, respectively;

FIG. 16a shows the arrangement of FIGS. 15a and 15b, in which a fiber ferrule is coupled to the optoelectronic transducer module;

FIG. 16b shows an arrangement corresponding to FIG. 16a, the leadframe adapter being of a pluggable form;

FIGS. 17a,17b show a leadframe adapter with a transmitting module and a leadframe adapter with a receiving module in an arrangement next to each other, both in front view and in side view, respectively, the contacts of the leadframe adapter which can be connected to a printed circuit board being formed as clamping contact pins;

FIG. 18 shows the arrangement of FIGS. 17a and 17b after introduction into a surrounding housing and arrangement on a main circuit carrier;

FIGS. 19a-19c show a leadframe adapter with a transmitting module and a leadframe adapter with a receiving module in an arrangement next to each other, in front view, respectively, in side view and in rear view, the contacts protruding from the leadframe adapter running parallel to the optical axis of the associated module; and

FIG. 20 shows the transmitting and/or receiving arrangement of FIGS. 19a, 19b, 19c after introduction into a surrounding housing, arrangement in a housing compartment and connection to a main circuit board by means of a plug-in adapter.

### DETAILED DESCRIPTION OF THE INVENTION

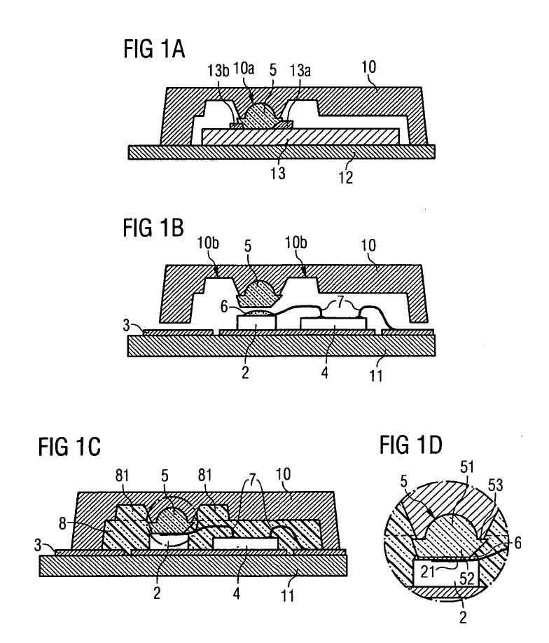

FIGS. 1a to 1c show a possible production sequence in the production of an optoelectronic transducer module. An injection molding tool with an injection molding cover 10 in which a lens structure 10a is incorporated is represented. The lens structure 10a serves for receiving an optical functional element, which in the exemplary embodiment represented is formed as a transparent lens 5. The lens 5 is integrated in the injection molding cover 10 in a first method step according to FIG. 1a. For this purpose, the lens 5 is arranged in a holder 13a, 13b on a substrate 13, which is fastened on a heating carrier die 12. It may optionally be provided in this case, by heating the heating carrier die 12, for the lens 5 to be “subsequently embossed”, in that the material of the lens 5 is made to fit into the lens structure 10a of the injection molding cover 10.

According to FIG. 1b, arranged on a base part 11 of the injection molding device is a circuit carrier in the form of a leadframe 3, on which an optoelectronic transducer component 2 and an associated circuit component 4 are arranged. The electrical contacting takes place by means of bonding wires 7. An optically transparent adhesive 6 is then applied to the surface of the transducer component 2. This preferably takes place before the arrangement is introduced into the injection mold 10, 11. After closing the injection mold according to FIG. 1c, the lens 6 comes into contact with the adhesive 6. As this happens, the latter is compressed to the extent of the tolerance in the height of the components, i.e. all that remains is a layer of adhesive of small thickness. By heating up the injection mold 10, 11, the adhesive 6 is cured to the extent that it is no longer possible for the injection molding compound to enter into the region of the optical window formed by the lens 5.

By injecting luminant injection molding compound 8, the optical component is packaged. The luminant injection molding compound 8 is in this case transparent, but has additional fillers, by which the thermal properties of the injection molding material can be set in a suitable way.

It is pointed out in FIG. 1B that a clearance lob in the cover 10 of the injection molding tool produces a structure 81 on the package 8 for passive coupling to a fiber ferrule guide. In the exemplary embodiment represented, this coupling structure 81 is of a circular form.

It can be seen from the view of a detail of FIG. 1d that the lens 5 comprises a basic element 52 which is trapezoidal in section and a lens body 51 which is arranged on it. The basic element 52 which is trapezoidal in section has overlaps 53 into the injection molding compound 8, which lead to mechanical hooking and engagement of the lens 5 in the injection molding material 8, so that the lens 5 is reliably arranged mechanically on the package 8 even after removal of the injection molding cover 10.

The adhesive 6 has been thinned to the height tolerance and cured by heating. It therefore absorbs the production tolerance in the height of the components 3, 2, 5 arranged one on top of the other. By heating up the injection mold, the adhesive is cured to the extent that it withstands the pressure of the injection molding compound, so that none of it enters the optical path of rays. Like the adhesive 6, the lens 5 is located above the optically active surface 21 of the transducer component 2 (see FIG. 1D).

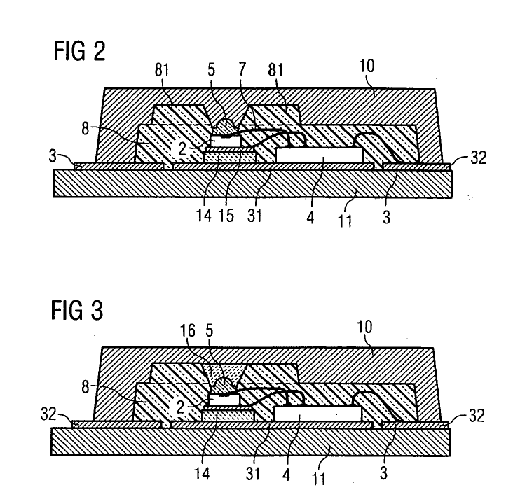

FIG. 2 shows the finished optoelectronic transducer module, still arranged in the injection molding tool 10, 11. There are differences in relation to the refinement of FIGS. 1A-1D, to the extent that the transducer component 2 in this refinement is arranged on an insulating, heat-conducting submount 14. A submount 14 is used whenever the anode contact and the cathode contact of the transducer component 2 lie on different sides. Contacting of the transducer component 2 takes place in this case partly by means of metallizations 15 on the submount 14. If the anode contact and the cathode contact of the transducer component 2 lie on the same side, the transducer component 2 may also be mounted directly on the leadframe 3.

The leadframe 3 has a mounting surface 31 for fastening the optoelectronic transducer component 2 or submount 14 and also the electrical component 4. Furthermore, the leadframe 3 has contact leads 32, to which bonding is carried out and which protrude from the package 8. The structuring of the leadframe 3 takes place in a way known per se by punching out or chemical etching.

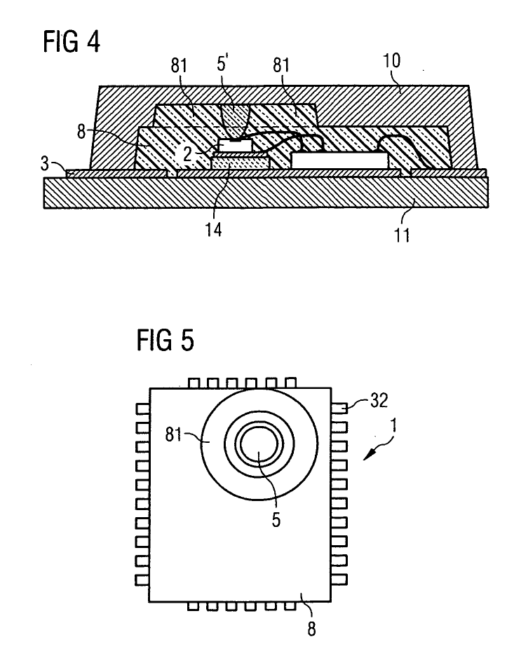

In the case of the exemplary embodiment of FIG. 3, a molded body 16 is additionally provided, consisting for example of Teflon or LCP and having on its side facing the lens 5 a functional surface corresponding to the lens. By contrast, the side of the molded body 16 facing away from the lens 5 is smooth and runs parallel to the injection molding cover 10. The advantage of this configuration is that no three-dimensional structures have to be formed in the injection molding cover 10, but instead it can be formed in a planar manner. The requirement of a separate part 16 may, in some cases, be disadvantageous. The molded body 16 is removed again after the injection molding compound has been injected and cured. For simple removal, it preferably has a conical form.

It is pointed out that, in a first method step, even when an additional molded body 16 is used, the lens 5 together with the molded body 16 is firstly arranged on the injection molding cover in a way corresponding to FIG. 1a. Suitable adhesives are provided for this purpose.

It should also be noted that the molded body 16 consists of a material to which the injection molding compound 8 does not bond. If appropriate, injection molding compound 8 can additionally be prevented from penetrating by means of adhesive between the molded body 16 and the lens 5.

In the case of the exemplary embodiment of FIG. 4, the optical functional element is formed by a mode funnel (taper) 5′. This may have a vapor-deposited metallic coating on its side wall or alternatively be characterized by a core-casing structure. Here, too, the injection molding cover 10 may be of a planar form. The mode funnel 5′ is firstly fastened to the injection molding cover 10. The method is comparable with the method of FIGS. 1a-1c.

It is pointed out that in the above example the mode funnel 5′ tapers downward.

As in FIGS. 2 and 3, a coupling structure 81, which serves for passive coupling to a fiber ferrule guide, is formed on the upper side of the package 8 in FIG. 4.

FIG. 5 shows a plan view of the transducer component 1 removed from the injection molding device. In the exemplary embodiment represented, the contact leads 32 of the leadframe are led out on four sides. However, the number of leadframe contacts 32 and their shaping is absolutely freely selectable. The passive coupling structure 81 represented in FIGS. 1 to 4 on the package 8 is evident as a cylindrical elevation. It serves for fixing in a matching inner cylinder of a fiber ferrule guide by passive alignment. An optical window for the coupling in and/or out of light is provided on the upper side of the transducer module by the optical functional body 5.

In the case of the exemplary embodiments described, it can be regarded as a special feature that coupling in and out of light does not take place through the leadframe 3, but in the direction of the surface of the package 8 (top window). With such an arrangement of the module, there was previously the problem that the casting material is located above the transducer component 2 and is accordingly transradiated by the light received or emitted. This has the result that the casting material must be of a transparent form. In particular, the adding of fillers is possible only to an extremely small extent, since with a high degree of filling there is a lack of transparency on account of scattering. However, a disadvantage of a highly transparent casting material is that there is no adaptation in the thermal expansion to the further components of the module.

The solution described solves this problem to the extent that the window region transradiated by light is formed by an optical functional element 5, 5′ which is arranged as a separate, transparent part above the transducer component 2 and at the same time within the casting material 8. The casting material 8 can then be adapted unproblematically in terms of expansion, for instance by adding fillers. It is also possible in principle to use a nontransparent, black casting compound which is adapted well in its coefficient of expansion to the leadframe and the individual parts.

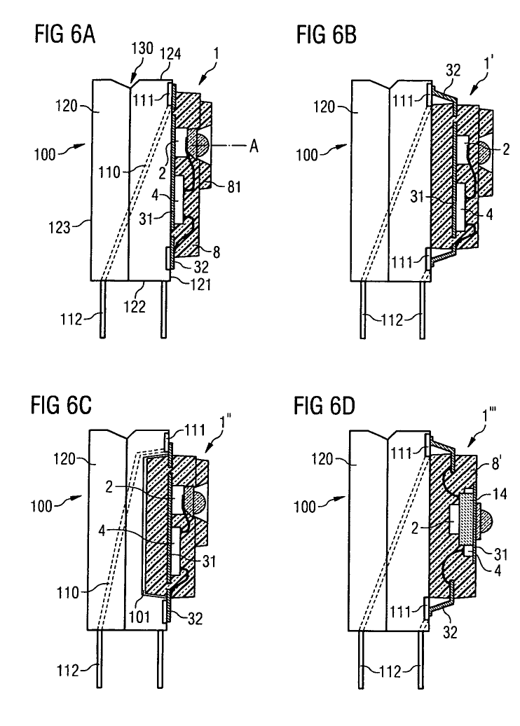

FIGS. 6a to 6d show an adapter 100, on one side of which a transducer module 1, 1′, 1″, 1′″ is arranged. As still to be explained, the adapter 100 has a leadframe structure, for which reason the adapter 100 is also referred to hereafter as leadframe adapter 100.

The leadframe adapter 100 can be used with transducer modules 1, 1′, 1″, 1′″ of different types of construction, which are represented by way of example in FIGS. 6a to 6d.

In the exemplary embodiment of FIG. 6a, the transducer module 1 is a “top” emitting or receiving optoelectronic transducer module according to FIGS. 1A to 5. The module 1′ of FIG. 6b is what is known as a “balanced” module, the package of which is formed by a clear casting material. The module 1′ is referred to as “balanced” since the volume of the module mass in front of and behind the leadframe 31 of the module is the same. There is accordingly no bimetallic effect. In the case of the exemplary embodiment of FIG. 6c, a clearly molded or cast “balanced” module 1″ is likewise obtained, the contact leads 32 of the leadframe being formed straight here, while they are bent in the case of the module 1′ of FIG. 6b. Accordingly, the leadframe adapter 100 has an associated trough 101, in which the module 1″ is partly received.

FIG. 6d shows a transducer module 1′″ in a leadframe type of construction which has a nontransparent casting material 8′. Coupling in and out of light takes place through an opening in the carrier board 31 of the leadframe. The transducer component 2 is arranged with the upper side downward on a transparent substrate 14, which is fastened on the leadframe 31. The leadframe contact leads 32 are bent in the direction of the leadframe adapter 100.

In FIG. 6a, the optical axis A of the transducer component 2 and of the transducer module 1 is additionally depicted.

In all the exemplary embodiments of FIGS. 6a-6d, a leadframe adapter 100 is provided, having an adapter body 120 comprising a nonconducting material and with a front side 121, a rear side 123, an underside 122 and an upper side 124. The adapter body 120 has a substantially cuboidal form. On the upper side 124 there is a notching 130, which provides a latching structure.

On the planar front side 121, facing the module 1, there are first electrical contacts 111. From the underside 122 of the adapter module there protrude two electrical contacts 112. In this case, a first electrical contact 111 and a second electrical contact 112 are respectively electrically connected to one another by means of a conductor 110 running inside the adapter body 120.

In particular, the conductors 110 form a conductor pattern on a leadframe basis, a conductor 110 respectively being formed by an elongate metal structure, the ends of which respectively provide a first contact 111 and a second contact 112.

The first contacts 111 are formed in a substantially planar manner in the front side 121 of the adapter body 120. They are soldered or welded to the contact leads 32 of the transducer module 1 arranged on the front side 121. This has the effect on the one hand of producing electrical contacting of the contact leads 32 of the transducer module 1 and on the other hand of producing mechanical fastening of the transducer module 1 to the adapter 100.

The leadframe adapter 100 is also represented in plan view and in side view without the transducer module in FIGS. 8a, 8b.

It is pointed out that, in all the exemplary embodiments of FIGS. 6a-6d, the transducer module 1, 1′, 1″, 1′″ contains on the mounting surface 31 of the leadframe both the optoelectronic transducer device 2 and an associated wiring device 4, for example a driver device or a preamplifier device. It is consequently not necessary to arrange electrical devices correspondingly on a separate, internal printed circuit board. Rather, contacting of the module 1, 1′, 1″, 1′″ with respect to a main circuit carrier can take place directly by means of the leadframe adapter 100.

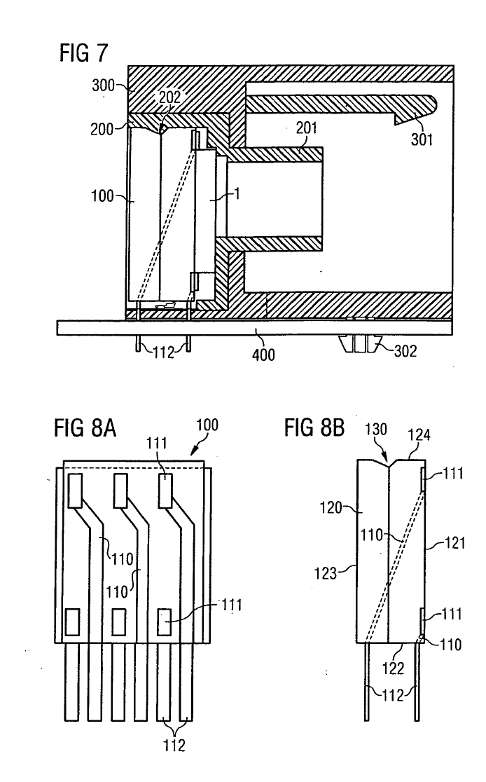

FIG. 7 shows the transmitting and/or receiving arrangement of FIG. 6a in a package 200, which serves on the one hand for receiving the arrangement comprising the adapter 100 and the transducer device 1 and serves on the other hand for forming a coupling region 201 for receiving an optical fiber. The package 200 receiving the leadframe adapter 100 has in this case a detent 202, which engages in the corresponding clearance or notch 130 on the upper side of the leadframe adapter 100, so that mutual latching engagement takes place.

The package 200 is in turn located in a surrounding housing 300 (also referred to as a “header”), which serves for receiving an optical plug, a latching element 301 for a latching engagement of such a plug being integrated in the surrounding housing 300. By means of a latching element 302 arranged on the underside of the surrounding housing 300, a mechanical connection of the surrounding housing 300 and the components arranged therein takes place on a printed circuit board 400, which is, for example, a main circuit board on which the entire arrangement is arranged. The second contacts 112 of the adapter 100, protruding downward from the adapter 100 as pins, are in this case arranged in corresponding via holes of the printed circuit board 400.

It is consequently possible with the leadframe adapter 100 to connect the electrical contacts of the optoelectronic transducer module 1 to the printed circuit board 400. The plugging direction is perpendicular in relation to the optical axis of the transducer module 1.

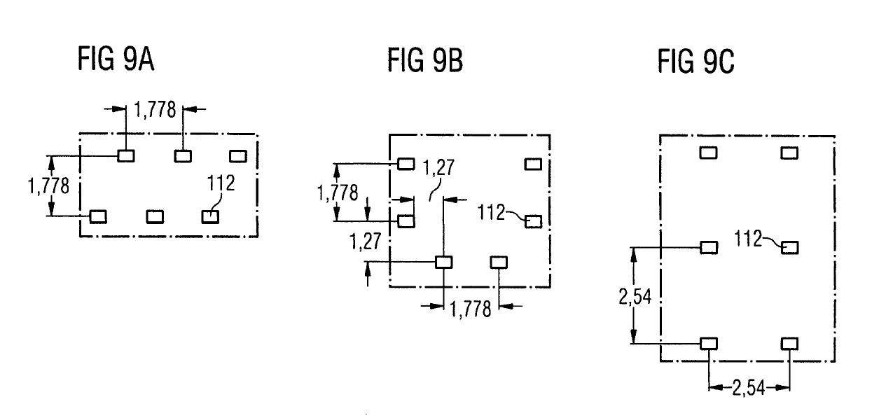

Examples of the “footprint” of the leadframe adapter 100 are represented in FIGS. 9a, 9b and 9c. This is the spatial arrangement of the second contacts 112 of the leadframe adapter in a plane parallel to the underside 122 of the adapter or parallel to a printed circuit board into which the contacts 112 are inserted.

It can be seen that the “pitch”, i.e. the spacing between individual contacts 112, can be chosen variously, for example may have a spacing of 1.778 mm (FIG. 9a), a spacing of 1.778 and 1.27 mm (FIG. 9) or a spacing of 2.54 mm (FIG. 9c).

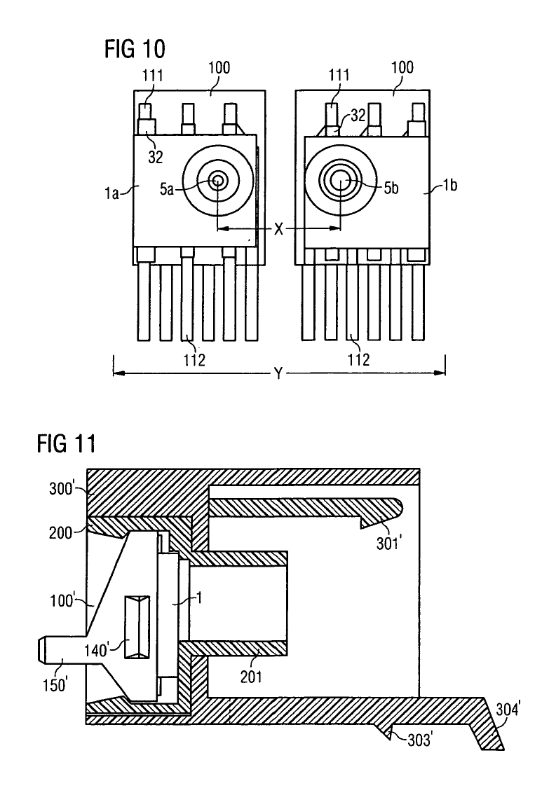

FIG. 10 shows a transmitting transducer module 1a, produced according to FIGS. 1A to 5, and a receiving transducer module 1b, produced in a way corresponding to FIGS. 1A to 5, in an arrangement next to each other and respectively mounted on a leadframe adapter 100. It can be easily seen in the front view represented that the contact leads 32 of the leadframe of the modules 1a, 1b are in each case connected mechanically and electrically to a first contact 111 of the leadframe adapter 100. By contrast, the second contacts 112 protrude from the underside of the leadframe adapter 100.

The spacing X between the two optical axes of the modules 1a, 1b is for example 5 mm. The overall width of the modules 1a, 1b arranged next to each other is preferably below the width Y of 13.5 mm which is to be maintained for SFF transceivers. The modules can consequently be used in an SFF transceiver. As represented in FIG. 7, the two contacts 112 of the adapter 100 in this case directly contact a main circuit board on which the transceiver is arranged.

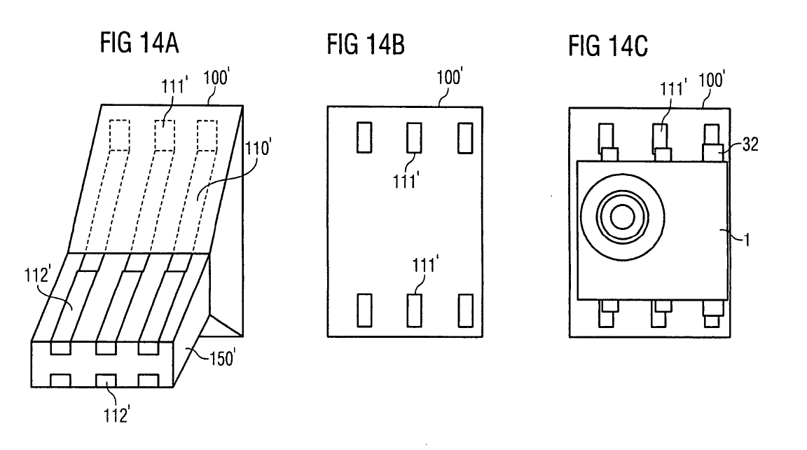

FIG. 11 shows an optoelectronic transmitting and/or receiving device which is comparable in its basic construction to that of FIG. 7, to which reference is made to this extent. In the case of this refinement, however, the surrounding housing 300′ and a leadframe adapter 100′ are configured to allow plugging in the horizontal direction (i.e. in the direction of the optical axis of the transducer module 1). For this purpose, the surrounding housing 300′ has on the underside a tongue-like rocker 304′ with a detent 303′. Furthermore, on the leadframe adapter 100′ there are latching-in structures 140′. The refinement is of a form suitable for an SFP transceiver. As to be explained in still more detail on the basis of FIGS. 14a-14c, the two contacts of the leadframe adapter 100′ are not located on the underside of the adapter 100′, as in the case of the previous exemplary embodiments, but on a rearward, protruding coupling region 150′ of the adapter body.

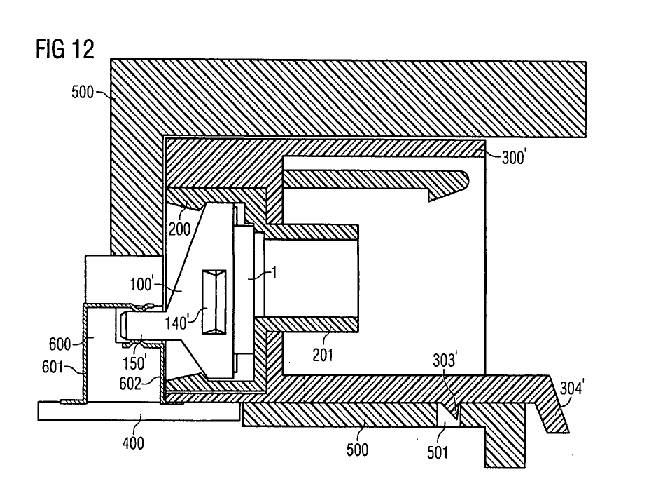

FIG. 12 shows the SFP transceiver of FIG. 11 inserted into a housing compartment 500 and arranged on a printed circuit board 400. The detent 3031 of the surrounding housing 300′ is in this case latched in a clearance 501 of the housing compartment 500. By raising the tongue-like rocker 304′, the pluggable transceiver can be pulled out again from the housing compartment 500. In FIG. 12 there can also be seen a plugging adapter 600, which has electrical contact springs 601, 602. The electrical contact springs 601, 602 are bent round on their side facing the printed circuit board or main circuit board 400 to produce an SMD contact. On their side facing away from the printed circuit board 400, the contact springs 601, 602 contact the rearward coupling region 150′ of the adapter 100′, on which the second contact springs of the adapter are arranged.

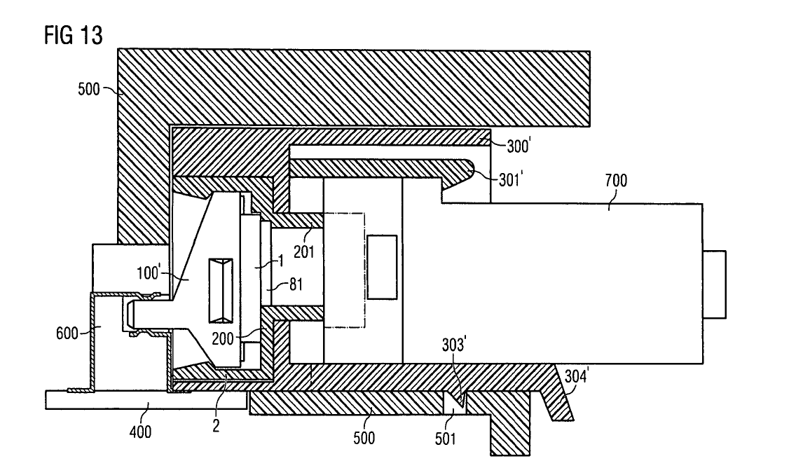

FIG. 13 shows the connecting arrangement of FIG. 12 after inserting an optical plug 700 into the receiving opening of the housing compartment 500. In this case, an optical fiber arranged in the optical plug 700 is introduced into the coupling region 201 of the package 2. The optical fiber is thereby inserted into the coupling region 201 until it comes up against the coupling structure 81 of the module 1 (see also FIG. 6a).

The latching element 301′ of the surrounding housing 300′ serves for the latching engagement of the optical plug 700 in the housing compartment 500. It is also pointed out that, after introducing the plug 700 into the housing compartment 500, the surrounding housing 300′ can no longer be removed from the housing compartment 500, since the tongue-like rocker 304′ can no longer be deflected. Consequently, with the plug 700 inserted, detachment is no longer possible even in the case of vibrations.

FIGS. 14a-14c show the leadframe adapter 100′ that is modified in comparison with FIGS. 6a-6d, 8a and Bb. In the case of the leadframe adapter 100′, the conductors 110′ extend from the first contacts 111′ on the planar front side of the adapter in the direction of the rear side of the adapter in such a way that they form spaced-apart upper and lower contacts 112′ in the rearward coupling region 150′, protruding to the rear. The contacts 112′ are accordingly formed on the upper side and on the underside of the coupling region 150′. FIG. 14b shows the front side of the adapter 100′ without the transducer module, FIG. 14c shows the front side with the transducer module 1. With regard to the forming of the front side, there are no differences from the refinement of FIGS. 8a and 8b.

It is pointed out that the contacts 112′, which according to FIGS. 12 and 13 come into contact with the plugging adapter 600 arranged on the printed circuit board 400, can be galvanically modified, so that a high plugging number is achieved. For this purpose, nickel and/or gold is chemically applied in the region of the plugging contact surface, for example after production of the adapter. The outer layer with gold chemically applied suppresses the formation of corrosion.

It is also pointed out that all the modules according to FIGS. 6a-6d and also other modules constructed in a corresponding way can of course also be combined with a pluggable leadframe adapter according to FIGS. 14a-14c.

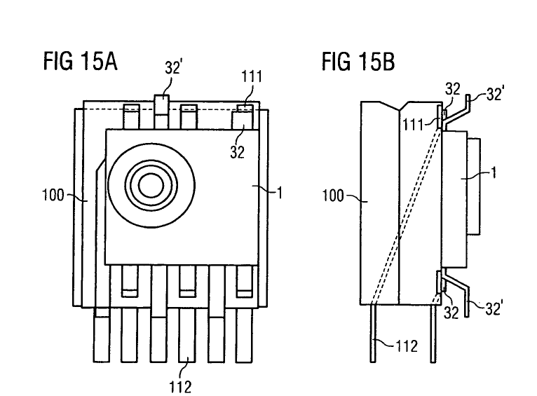

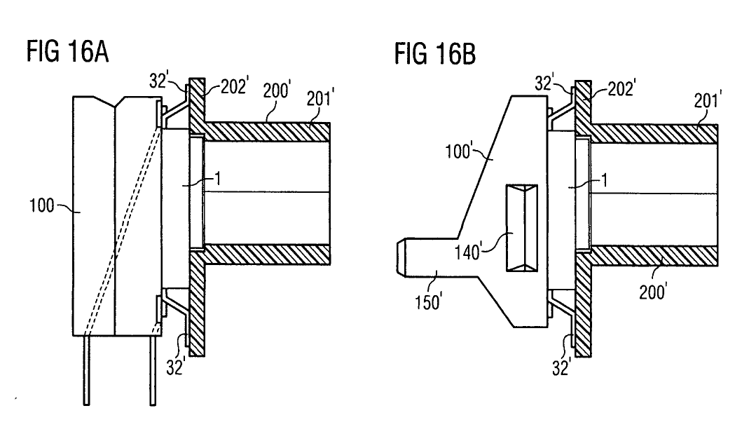

Represented in FIGS. 15a and 15b is a modified exemplary embodiment of a module 1 which provides the possibility of coupling a ferrule of a single-mode fiber to the module 1. For this purpose, a plurality of contact leads 32′, for example three of them, of the leadframe of the transducer module 1 are bent in the direction of the surface of the module 1. As described before, other contact leads 32 are coupled to the adapter 100. As represented in FIG. 16a, a ferrule fiber plug 200′ for a single-mode or multi-mode glass fiber can be fastened directly to the module 1 by means of the additional contact leads 32′, bent in the direction of the surface of the module 1. The fastening takes place by active adjustment and laser welding of a flange surface 202′ of the fiber plug 200′ directly to the bent contact leads 32′. A cylindrical sleeve 201′ of the ferrule fiber plug 200′ serves for receiving a fiber.

If the ferrule 200′ does not consist of metallic material, the contact leads 32′ are preferably formed in such a way that they are connected to the ferrule 200′ by material transport under the effect of a laser.

FIG. 16b shows a corresponding refinement for the case in which the leadframe adapter 100′ is formed to allow plugging with latching elements 140′ and a rearward coupling region 150′, corresponding to FIG. 14a. Otherwise, there are substantially no differences from the refinement of FIG. 16a.

The arrangement of FIGS. 16a and 16b can be installed in a way corresponding to FIGS. 7, 12 and 13 into an SSF and/or SFP transceiver for single-mode or multi-mode glass fiber transmission systems.

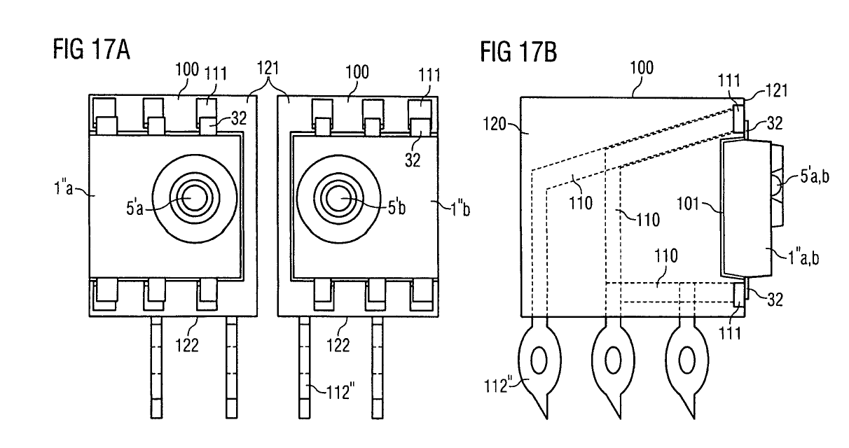

FIGS. 17a and 17b show a configuration of the leadframe adapter with clamping contact pins 112″, in particular for use in automotive applications. Increased requirements for contact stability are imposed there because of the high vibrational loads.

The clamping contacts are for example configured for a pitch of 2.54 mm. There are no differences in respect of the basic construction from the previous exemplary embodiments, so that reference is made to this extent to the latter. However, it should be noted that a “balanced” transducer module 1″a, 1″b is represented by way of example in FIGS. 17a, 17b, having straight contact leads 32 and arranged partly in a trough 101 of the leadframe adapter 100. A coupling lens 5′a, 5′b is configured in a way corresponding to the package of FIG. 6a (“Top Optical Window Package”) or in the case of the transparent package 1″a, 1″b is configured such that it is integrated in resin.

The routing of the electrical conductors 110 inside the adapter package 120 differs from the previous exemplary embodiments to the extent that the 2-dimensional contact print with respect to the transducer module 1″a, b (comprising the first contacts 111 arranged in two horizontal rows) is transformed into a 2-dimensional footprint with respect to the main circuit board (comprising the two contacts 112″ on the underside 122 of the module), in which the second contacts 112″ run in two rows which run perpendicularly in relation to the rows of contacts on the front side 121. This shows by way of example that, by suitable bending and shaping of the conductors 110, any desired formation can be obtained between the first and second contacts 111, 112.

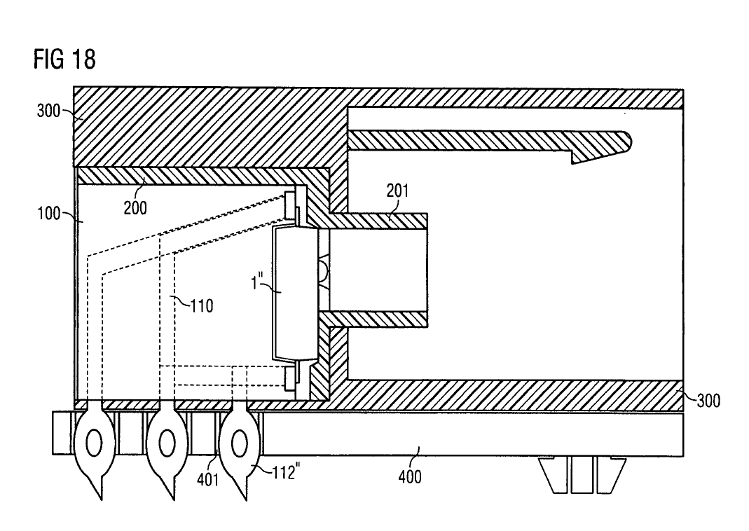

FIG. 18 shows the adapter 100 of FIG. 17 and the associated transducer module 1″ in a package 200 with a coupling region 201 for receiving an optical waveguide and a surrounding housing 300, which is arranged on a main circuit board 400. A vertically pluggable configuration is obtained. The clamping contact pins 112′ come into contact with via holes 401 of the main circuit board 400. A construction comparable to the refinement of FIG. 7 is obtained.

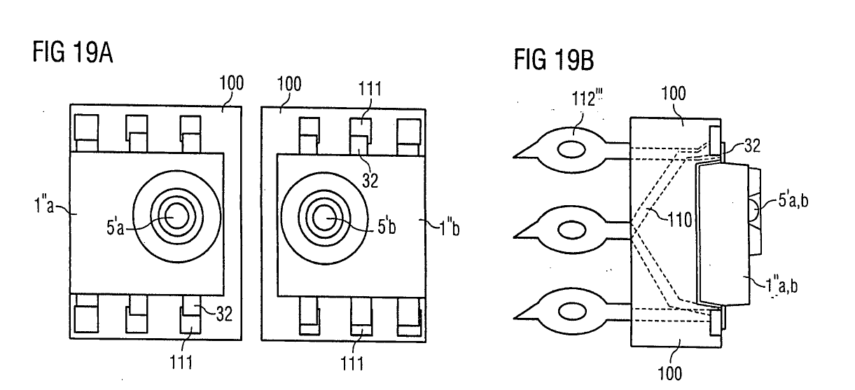

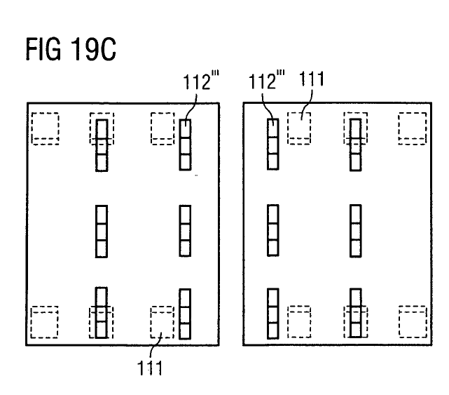

In the exemplary embodiment of FIGS. 19a, 19b and 19c, the leadframe adapter 100 has horizontally pluggable second contacts 112′″, which in turn are formed as clamping contact pins. Apart from the fact that the clamping contact pins 112′″ protrude from the rear side of the adapter 100, a construction which is comparable to FIGS. 17a, 17b is obtained, so that reference is made to this extent to these figures. FIG. 19c shows the contact pattern on the rear side of the adapter 100. The first contacts 111, located on the front side of the adapter 100, are represented by dashed lines. Two rows with three clamping contact pins are respectively provided.

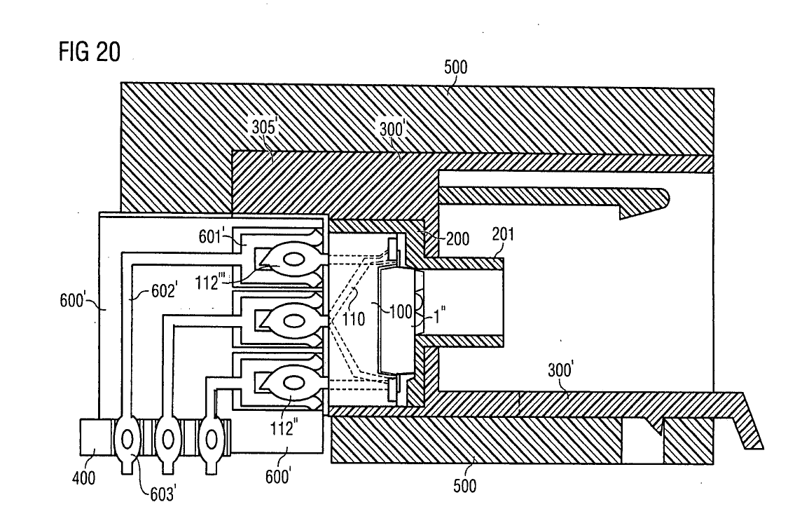

FIG. 20 shows the arrangement of a horizontally pluggable transmitting and/or receiving arrangement according to FIGS. 19a-19c in a package 200 and a surrounding housing 300′, the entire arrangement having been inserted in a housing compartment 500 corresponding to the housing compartment of FIG. 13. An electrical connection of the clamping contact pins 112′″ to a main circuit board 400 takes place by means of a plugging adapter 600′, which has leads 602′ (for example likewise formed as leadframe leads), which extend between a double-sided contact 601′ and further clamping contact pins 603′, the latter being connected to the circuit board 400.

The plugging adapter 600′ is pre-mounted on the circuit board 400, so that the transceiver can be arranged to allow horizontal plugging on the main circuit board 400 or in the housing compartment 500. The clamping contact pins 112′″ thereby contact the horizontally running double-sided contacts 601′ of the plugging adapter 600′.

The plugging adapter 600′ is mounted on the main circuit carrier 400 in such a way that the compressive forces occurring during plugging cannot act on the clamping contact pins 603′. Furthermore, the surrounding housing 300′ rises above the clamping contact pins 112′″ of the leadframe adapter 100 so far that no mechanical deforming forces can act on the clamping pins 112′″ of the adapter 100. For this purpose, an overhang 305′ of the surrounding housing 300′ is formed in a U-shaped manner on the rear side of the surrounding housing 300′, providing three-sided kojiri protection with respect to clamping forces occurring.

Although the invention has been illustrated and described with respect to one or more implementations, alterations and/or modifications may be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. An adapter configured to connect an optoelectronic transducer module to a printed circuit board, comprising:
an adapter body comprising a nonconducting material having a first, planar side, a plurality of first electrical contacts, and a plurality of second electrical contacts, wherein
the first electrical contacts are arranged on the first, planar side of the adapter body,
the second electrical contacts are arranged on a second, another side of the adapter body, and
respective ones of the first electrical contacts and the second electrical contacts are electrically connected to one another by means of a plurality of conductors running inside the adapter body.

2. The adapter according to claim 1, wherein the plurality of conductors form a conductor pattern comprising a plurality of elongate conductive structures, the ends of which respectively couple to a first and a second electrical contact.

3. The adapter according to claim 1, wherein the second contacts are arranged on an underside of the adapter body that runs perpendicularly in relation to the first side provided with the first contacts.

4. The adapter according to claim 1, wherein the second contacts are arranged on a rear side of the adapter, that is opposite from the planar side provided with the first contacts.

5. The adapter according to claim 1, wherein the first contacts are formed in substantially the same plane as the corresponding first side of the adapter body.

6. The adapter according to claim 1, wherein the second contacts comprise pins protruding from the adapter body.

7. The adapter according to claim 6, wherein the second contacts comprise clamping pins protruding from the adapter body.

8. The adapter according to claim 1, wherein the adapter body comprises a substantially cuboidal form.

9. The adapter according to claim 1, wherein the adapter body further comprises one or more latching structures configured to facilitate a latching engagement with a package or other structures.

10. The adapter according to claim 1, wherein the first contacts form a two-dimensional pattern on the first, planar side and the second contacts form a two-dimensional or three-dimensional pattern on the second side.

11. The adapter according to claim 10, wherein the second contacts are arranged on the second side in at least two spaced-apart rows.

12. The adapter according to claim 1, wherein the conductors extend from the first contacts on the first, planar side comprising a front side of the adapter body in a direction of an opposing, rear side of the adapter body in such a way that the conductors couple to spaced-apart upper and lower second contacts in a rearward, protruding coupling region of the adapter body, wherein the second side comprises the rear side.

13. The adapter according to claim 1, wherein the adapter body has on the first, planar side a clearance formed therein configured to partly receive a transducer module therein, the first contacts being arranged on the first, planar side outside the clearance.

14. An optoelectronic transmitting and/or receiving arrangement with an optoelectronic transducer module, comprising:
a transducer component;
a leadframe comprising a mounting surface configured to fasten to another structure, and comprising contact leads configured to electrically contact the transducer component;
a module package surrounding the transducer component, the module package comprising an upper side and comprising an underside from which the contact leads of the leadframe protrude, wherein an optical axis of the transducer module extends perpendicularly in relation to the mounting surface, and wherein a coupling in and out of light occurs through the upper side of the module package; and
an adapter configured to connect the transducer module with the module package to a printed circuit board, comprising:
an adapter body comprising a nonconducting material having a first, planar side, a plurality of first electrical contacts, and a plurality of second electrical contacts, wherein
the first electrical contacts are arranged on the first, planar side of the adapter body,
the second electrical contacts are arranged on a second, another side of the adapter body, and
respective ones of the first electrical contacts and the second electrical contacts are electrically connected to one another by means of a plurality of conductors running inside the adapter body, wherein
the module package is configured with its underside on the first, planar side with the first electrical contacts of the adapter body are electrically connected to the contact leads of the leadframe of the transducer module.

15. The arrangement according to claim 14, wherein the second contacts of the adapter body are configured to connect directly to a circuit board, wherein the second side comprises an underside of the adapter body that runs perpendicularly in relation to the first, planar side connected to the module package.

16. The arrangement according to claim 14, wherein the second contacts are configured to connect to a circuit board with a plugging adapter interposed therebetween, wherein the second contacts are arranged on a rear side of the adapter body opposite the first, planar side connected to the module package, wherein the plugging adapter is configured to connect to a circuit board.

17. The arrangement according to claim 14, wherein some of the contact leads of the leadframe of the transducer module are bent away from the adapter body and are configured to provide mechanical fastening points for a coupling of a fiber ferrule to the transducer module.

18. The arrangement according to claim 14, wherein the adapter is connected to an electrical circuit board that lies in a plane which runs parallel to the optical axis of the transducer module.

19. The arrangement according to claim 14, wherein the first electrical contacts of the adapter body are soldered or welded to the contact leads of the leadframe of the transducer module.

20. The arrangement according to claim 14, wherein the transducer module further comprises at least one electrical component that interacts with the transducer component.

21. An optoelectronic transducer module, comprising:
a transducer component;
a leadframe comprising a mounting surface configured to fasten to another structure, and comprising contact leads configured to electrically contact the transducer component; and
a module package comprising a casting compound and surrounding the transducer component, the module package comprising an upper side and an underside, wherein an optical axis of the transducer module extends from the module package perpendicularly in relation to the mounting surface of the leadframe, and wherein a coupling in and out of light occurs through the upper side of the module package, and wherein
an upper side of the transducer component faces the upper side of the module package, and is connected by means of an optically transparent adhesive to a transparent optical functional body that provides an optical window in the upper side of the module package, and wherein the optical functional body is laterally surrounded by the casting compound of the module package.

22. The module according to claim 21, wherein the optical functional body comprises an optically transparent body with a beam-shaping surface via which light is coupled out of and into the module.

23. The module according to claim 21, wherein the optical functional body comprises a mode funnel having a diameter that increases outwardly in the direction of the module surface.

24. The module according to claim 21, wherein the optical functional body has overlaps configured to facilitate a form-locking engagement with the module package.

25. The module according to claim 21, wherein the optical functional body comprises a lateral clearance configured to receive a bonding wire fastened on the surface of the transducer component.

26. The module according to claim 21, wherein the casting compound of the module package comprises structures on a surface thereof configured to facilitate a passive coupling of an optical waveguide or a plug of an optical waveguide to the module.

27. The module according to claim 21, wherein the casting compound comprises an optically transparent material with filler added thereto having thermal properties adapted to thermal properties of other components of the transducer module due to a composition or amount of the fillers.

28. A method for producing an optoelectronic transducer module, comprising:
arranging a transducer component on a mounting surface of a leadframe;
contacting the transducer component to contact leads of the leadframe;
providing an injection molding device with a base part and an injection molding cover;
arranging an optical functional body on the injection molding cover;
arranging an optically transparent adhesive on an upper side of the transducer component facing the optical functional body arranged on the injection molding cover;
introducing the transducer component arranged on the leadframe into the injection molding device;
closing the injection molding device, thereby causing the optical functional body to contact the optically transparent adhesive;
filling the closed injection molding device with a casting material; and
opening the injection molding device and filling with casting material.

29. The method according to claim 28, wherein the optical functional body is fitted into a lens structure that is incorporated in the injection molding cover.

30. The method according to claim 28, further comprising placing a separate molded body between the optical functional body and the injection molding cover, wherein the molded body has on one side that is connected to the optical functional body a structure corresponding to the functional element, and has an opposing side that is connected to the injection molding cover is of a planar form.

31. The method according to claim 28, further comprising curing the optically transparent adhesive by heating before filling the injection molding device with a casting material.
